(19) United States
(12) Patent Application Publication
(10) Pub. No.: US 2012/0208454 A1
(43) Pub. Date: Aug. 16, 2012

(54) System and method for detecting and communicating with diverse near field communications adaptors

(75) Inventor: Heung-Keung Chai, Singapore (SG)

(73) Assignee: Cassis International Pte Ltd.

(21) Appl. No.: 12/931,774

(22) Filed: Feb. 10, 2011

(51) Int. Cl. H04B 5/00

(52) U.S. Cl. 455/41.1

(57) ABSTRACT

A system for operating near field communications adaptors of a computing device is disclosed, which includes at least one memory having at least one region for storing executable program code and at least one processor for executing the program code stored in the memory. When the program code is executed, it determines whether a near field communications adaptor is connected to the computing device; responsive to determining that a near field communication adaptor is connected to the computing device. Responsive to this determination, the program code identifies the adaptor and determines whether the computing device is adapted to communicate with the adaptor. Then, responsive to this further determination, the program code loads at least one device driver for the computing device to communicate with the adaptor.

### FIELD OF THE INVENTION

The present invention relates to a system and method for implementing a programming interface for near field communications (“NFC”) enable device, for example, a smart phone.

### BACKGROUND OF THE INVENTION

In the current computing environment, NFC is a standards-based, short-range wireless connectivity technology. Communication between two NFC devices occurs when they are brought within four to ten centimeters, or 1.5 to four inches, of one another. The loop antennas of the NFC devices, when located within this range of one another, effectively form an air-core transformer facilitating the communications between the devices. The advantages of NFC over other short range communications include convenience, speed of set up, security due to the limited physical range of operation, and low power consumption.

NFC is an open platform technology standardized in ECMA-340 and ISO/IEC 18092, which specify, among other things, the modulation schemes, coding, transfer speeds and initiation schemes underlying NFC. In addition, NFC is compatible with certain existing passive RFID infrastructures and incorporates other standards such as ISO/IEC 14443 and FeliCa.

Examples of NFC applications include contactless payment systems, electronic ticketing, and reading small amounts of information from NFC tags. In these examples, a simple tap of one NFC-enabled device with another facilitates the reading or writing of data. In the electronic payment example, an NFC application may require the user to confirm payment before the payment is actually processed. Other examples of NFC applications include peer-to-peer communications where two NFC-enabled devices transfer data to each other, such as exchanges of videos, contacts, photos etc.

NFC technology is gaining momentum and as more companies introduce new NFC-enabled devices and NFC adaptors, application programmers will be confronted with an increasing number of different application programming interfaces (“APIs”) and disparate application calling conventions in order to operate the NFC adaptor.

### SUMMARY OF THE INVENTION

In one aspect, the present invention is a system for operating near field communications adaptors of a computing device. The system comprises at least one memory having at least one region for storing executable program code and at least one processor for executing the program code stored in the memory. When the program code is executed, it performs the following: making a first determination of whether a near field communications adaptor is connected to the computing device; identifies the adaptor, wherein said identification is responsive to a first determination that a near field communication adaptor is connected to the computing device; makes a second determination of whether the computing device is adapted to communicate with the adaptor, wherein said making a second determination is responsive to the first determination that a near field communication adaptor is connected to the computing device; and loads at least one device driver for the computing device to communicate with the adaptor, wherein said loading is responsive to a second determination that the computing device is adapted to communicate with the adaptor.

In another aspect, the present invention is a method for operating near field communications adaptors of a computing device. The method comprises the following: making a first determination, by the computing device, of whether a near field communications adaptor is connected to the computing device, wherein the computing device includes at least one memory having at least one region for storing executable program code and at least one processor for executing the program code stored in the memory; identifying the adaptor by the computing device, wherein said identifying is responsive to a first determination that a near field communication adaptor is connected to the computing device; making a second determination, by the computing device, of whether the computing device is adapted to communicate with the adaptor, wherein said making a second determination is responsive to the first determination that a near field communication adaptor is connected to the computing device; and loading, by the computing device, at least one device driver for the computing device to communicate with the adaptor, wherein said loading is responsive to a second determination that the computing device is adapted to communicate with the adaptor.

In another aspect, the present invention is a system for operating near field communications adaptors of a computing device. The system comprises: at least one memory having at least one region for storing executable program code; at least one processor for executing the program code stored in the memory; means for making a first determination of whether a near field communications adaptor is connected to the computing device; means for identifying the adaptor, wherein said identifying is responsive to a first determination that a near field communication adaptor is connected to the computing device; means for making a second determination of whether the computing device is adapted to communicate with the adaptor, wherein said making a second determination is responsive to the first determination that a near field communication adaptor is connected to the computing device; and means for loading at least one device driver for the computing device to communicate with the adaptor, wherein said loading is responsive to a second determination that the computing device is adapted to communicate with the adaptor.

### BRIEF DESCRIPTION OF THE DRAWINGS

FIG. 1 illustrates a system of operating an NFC-enabled device according to one aspect of the system and method of the present invention;

FIG. 2 illustrates the software system for operating an NFC-enabled computing device according to the prior art;

FIG. 3 illustrates the one aspect of the software system for operating an NFC-enabled computing device according to one aspect of the system and method of the present invention;

FIG. 4 illustrates a flowchart for automatically determining and loading device drivers for an NFC adaptor according to one aspect of the system and method of the present invention.

The drawings are exemplary, not limiting. Items that are labeled with the same reference number in multiple figures refer to the same item throughout the figures.

### DETAILED DESCRIPTION

Various embodiments of the present invention will now be described in greater detail with reference to the drawings.

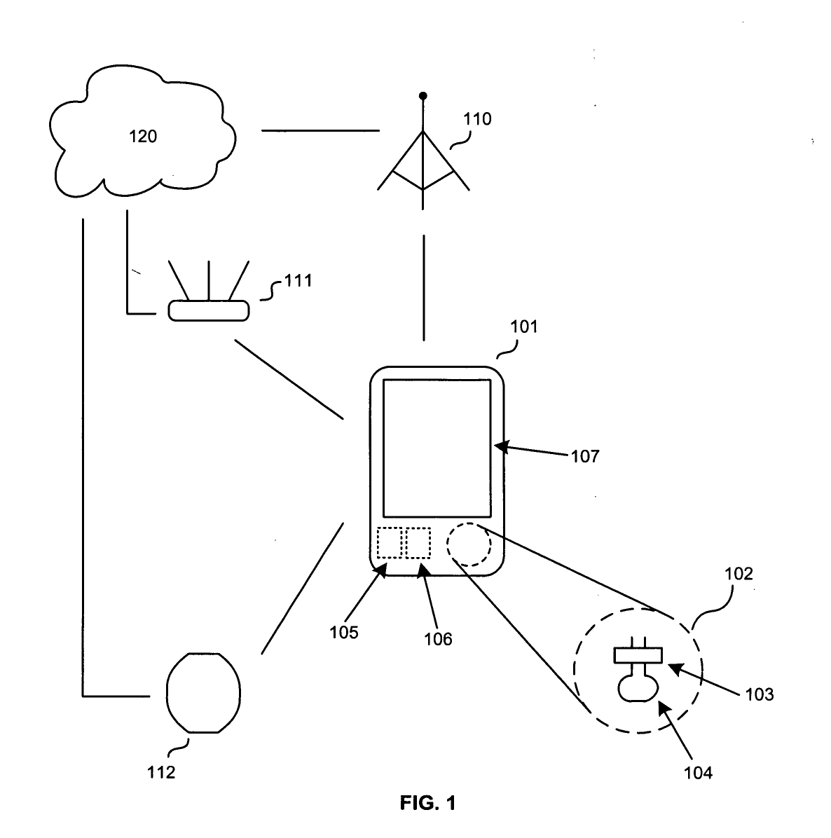

FIG. 1 illustrates a system according to one aspect of the present invention. FIG. 1 shows a Computing Device 101, which includes NFC Adaptor 102 which itself includes NFC Circuitry 103 and an NFC Antenna 104. Computing Device 101 may be a smart phone, tablet, portable computer, desktop computer, laptop computer, game console, personal media player, handheld computing device or portable gaming device. Computing Device 101 may include a one or more Display Screens 107, one or more transitory or non-transitory Memory 105, one or more CPUs 106, one or more input devices, one or more output devices, one or more wired or wireless network interfaces, one or more operating systems (including software layers for applications, device layers and run time environments) and one or more I/O communications ports.

In a preferred embodiment, Computing Device 101 is a smart phone. Smart phones are a well established class of mobile phones having more capability than a “feature phone” or a “dumb phone,” and which run a complete operating system software providing the user the ability to run advanced software applications. In one aspect, a Computing Device 101 that is a smart phone may include one or more display screens or touchscreen displays, one or more keyboards, one or more CPUs (which may be ARM-based processors or may be integrated in a system-on-a-chip architecture), one or more transitory or non-transitory memory, one or more mobile telecommunications modems, one or more wireless antennas, one or more operating systems, a SIM card, peripheral connectivity, Bluetooth® connectivity, GPS, one or more cameras, video output connectivity, and audio output capabilities. In addition, where Computing Device 101 that is a smart phone has a touchscreen display, a physical keyboard may be replaced or supplemented with a soft keyboard, on-screen keyboard or other touchscreen-based input capabilities.

Referring still to FIG. 1, NFC Adaptor 102 may be an active NFC adaptor, a passive NFC adaptor, an NFC adaptor capable of operating in both active and passive modes, or an NFC adaptor which can read, write, transfer and/or receive data from another NFC device. NFC Adaptor 102 may conform and/or be compatible with EXMA-340 and ISO/IEC 18092 and 14443 standards. NFC Adaptor 102 includes NFC Circuitry 103 and NFC Antenna 104. NFC Circuitry 103 performs, among other things, the functions necessary for modulation, demodulation, coding, initiation and, if necessary, encryption and decryption. In addition, in one aspect, NFC Adaptor 102 may be internally connected to Computing Device 101. In another aspect, NFC Adaptor maybe externally connected to Computing Device 101 (not shown), and this external connection may be a wired or wireless connection.

Referring still to FIG. 1, Network 120 may include any type of network infrastructure, such as client/server, peer-to-peer, or hybrid architectures. Network 120 may include a cellular network and/or the Internet. Where Network 120 is a cellular network, it may operate under any mobile telecommunications standard, such as 0G, 1G, 2G, 2G transitional, 3G, 3G transitional, 4G, pre-4G and/or other GSM, UTMS, TDMA, CDMA, GPRS, EDGE, mobile WiMax, or LTE related standards. Computing Device 101 may connect to Network 120 via Mobile Antenna 110 or Router 111. Computing Device 101 may connect to Mobile Antenna 110 using any of the mobile telecommunications standards mentioned above. Computing Device 101 may connect to Router 111 via a wired connection or wireless connection, such as any of the IEEE 802.11 WiFi standards, Bluetooth®, Wireless USB, or any other WAN, WLAN, or WPAN based standards.

As shown in FIG. 1, Computing Device 101 may interact with NFC Device 112. NFC Device 112 may be any NFC-enabled device, including electronic payment processor (e.g. point-of-sale terminal, kiosk etc.), electronic ticketing device, public transportation infrastructure, digital media display (e.g. electronic poster, electronic photo frame, television etc.), home theater, personal media player, security scanner, navigation device, automobile, computer, or smart phone. In one aspect, when Computing Device 101 is brought within close physical proximity with NFC Device 112 (for example, according to NFC standards, approximately four to ten centimeters, or approximately 1.5 to four inches), NFC Antenna 104 of NFC Adaptor 102 forms an effective air-core transformer with an antenna contained within NFC Device 112 (not shown), and this connection allows the Computing Device 101 and NFC Device 112 to interact with one another. Interactions between Computing Device 101 and NFC Device 112 may include: electronic payments, electronic ticketing, reading NFC tags, reading NFC-enabled posters and banners, smart card emulation (e.g. where Computing Device 101 and NFC Adaptor 102 behaves like a traditional contactless smart card), automatically establishing another contactless or wireless connection (e.g. a Bluetooth® connection), and transferring media or other information.

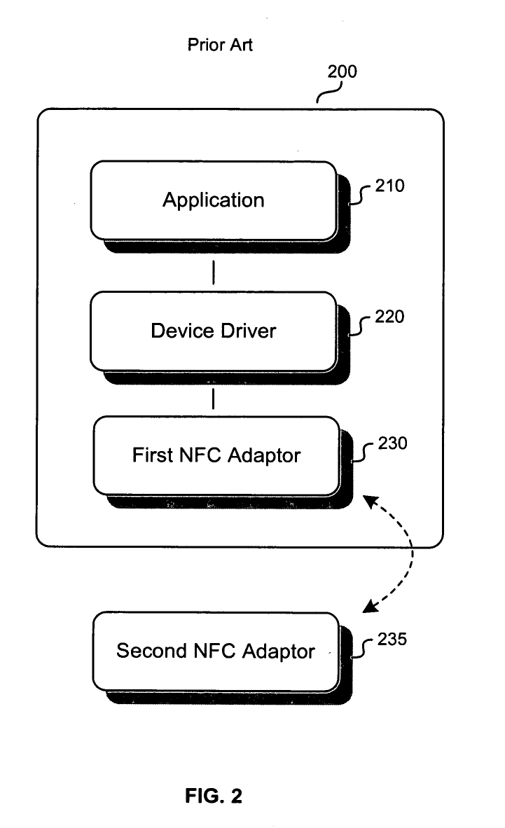

FIG. 2 illustrates one aspect of the prior art software and hardware system of an NFC-enabled Computing Device 200. First NFC Adaptor 230 is connected to, installed in or included in Computing Device 200. Application 210 is a software application on the NFC-enabled Computing Device 200. Device Driver 220 is the device driver necessary for Application 210 to interact with the specific First NFC Adaptor 230. In this example, when First NFC Adaptor 230 is replaced with Second NFC Adaptor 235, Application 210 will need to be modified to be able to operate Second NFC Adaptor 235. However, once Application 210 is modified to use Second NFC Adaptor 235, Application 210 will not be able to support any NFC adaptors other than Second NFC Adaptor 235.

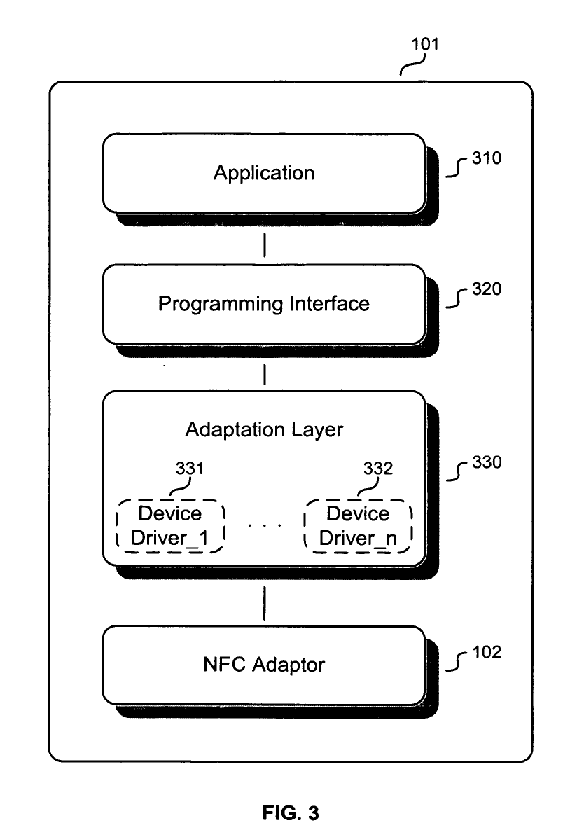

FIG. 3 illustrates one aspect the software and hardware system on Computing Device 101 of the present invention. These software aspects may be stored in one or more Memory 105 and executed by one or more CPUs 106. In one aspect, the software and hardware elements of FIG. 3 may operate in connection or in association with an operating system on Computing Device 101. In another aspect, the software elements of FIG. 3 may execute within an operating system on Computing Device 101. As shown in FIG. 3, Application 310 is a software application on Computing Device 101. Application 310 may be any software application carrying out an NFC interaction between Computing Device 101 and NFC Device 112 as, for example, described above. Programming Interface 320 provides a uniform programming interface for programmers and application developers. In addition, Programming Interface 320 invokes Adaptation Layer 330 to load the necessary device drivers for NFC Adaptor 102 (as explained below).

By using Programming Interface 320, programmers and application developers need not have specific knowledge of the APIs, function calls, and implementations of each different type or manufacture of NFC adaptors. Rather, programmers and application developers only need to know and program for the APIs, function calls, and implementations of Programming Interface 320 in order to operate and use NFC Adaptor 102. For example, Application 310 may interact or communicate with NFC Adaptor 102 to exchange application protocol data unit (APDU), issue APDU commands to the secure elements in NFC Adaptor 102, enable or disable the contactless interface, read or write MIFARE tags, read from or write to another NFC device or act as a reader. In all these examples and in other such interactions, the interactions between Application 310 and NFC Adaptor 102 may be performed via Programming Interface 320.

In one aspect of the present invention, when Application 310 invokes a function call through Programming Interface 320, Programming Interface 320 will map the function call to a corresponding function call associated with Adaptation Layer 330 and invoke that corresponding function call. Thus, for example, when Application 310 invokes a function call to exchange APDU information (or, ‘exchange_APDU’ call) through the Programming Interface 320, ‘exchange_APDU’ is mapped to a corresponding functional call associated with the Adaptation Layer 330 (or ‘internal_exchange_APDU’ call). Then, internal_exchange APDU is invoked to execute the commands associated with the function call to operate NFC Adaptor 102 to exchange the ADPU information.

Mapping of functional calls may be performed for all NFC function calls made by Application 310 through Programming Interface 320. In one aspect of the present invention, Programming Interface 320 provides a public and consistent programming interface for Application 310. In this manner, Adaptation Layer 330 may be modified independently without affecting Application 310.

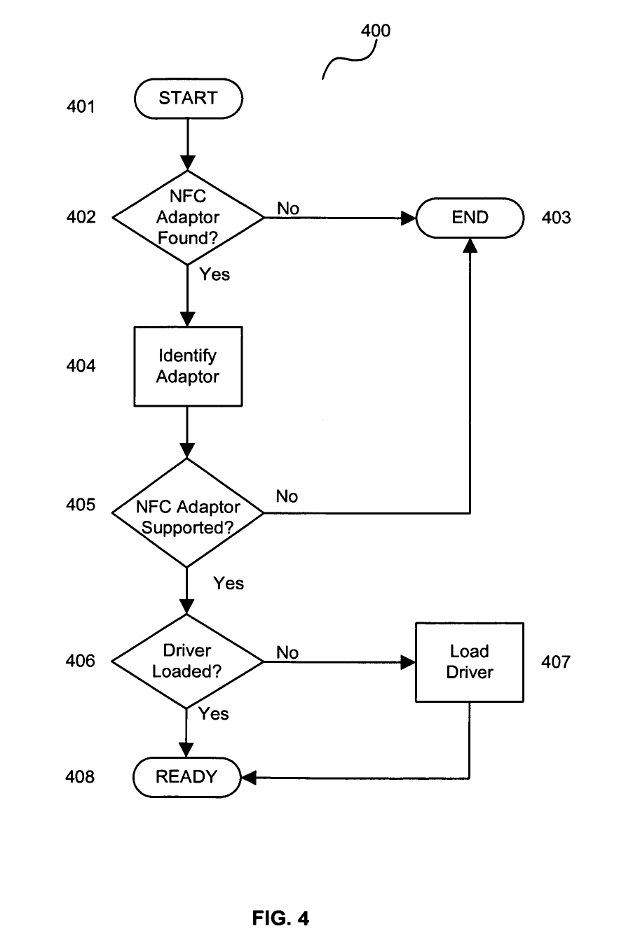

FIG. 4 illustrates a method according to aspects of the present invention of detecting and communicating with NFC adaptors. In this method, when Programming Interface 320 invokes Adaptation Layer 330, Adaptation Layer 330 identifies NFC Adaptor 102, checks against the list of supported NFC adaptors, and if a supported adaptor is found, loads and uses the corresponding device driver. This method is shown in process 400, which begins at step 401. Next, at step 402, Adaptation Layer 330 determines whether an NFC adaptor is present in Computing Device 101. If no NFC adaptor is found, Adaptation Layer 330 proceeds to step 403 where process 400 ends (i.e. Adaptation Layer 330 enters ‘End’ state). Alternatively, if an NFC adaptor is found in Computing Device 101, process 400 proceeds from step 403 to step 404 where Adaptation Layer 330 identifies the NFC adaptor.

Next, at step 405, Adaptation Layer 330 determines whether the NFC adaptor is supported by Computing Device 101. If the NFC adaptor is not supported, process 400 proceeds from step 405 to step 403 where process 400 ends. Alternatively, if the NFC adaptor is supported, process 400 proceeds from step 405 to step 406 where Adaptation Layer 330 determines whether any device drivers corresponding to the NFC adaptor are currently loaded. If no such device drivers are loaded, process 400 proceeds to step 407 where Adaptation Layer 330 loads the necessary device drivers for Application 310 and Programming Interface 320 to operate the NFC adaptor. Adaptation Layer 330 contains device drivers for all supported NFC adaptors, as shown at FIG. 3 as Device Driver_1 331 to Device Driver_n 332. These device drivers may be stored in the one or more Memory 105. In one aspect of the present invention, Adaptation Layer 330 may load the device drivers from the one or more Memory 105 to a device layer of an operating system of Computing Device 101. After step 407, Adaptation Layer 330 goes into a ‘Ready’ state at step 408. Alternatively, if the necessary device drivers are already loaded for the NFC adaptor, process 400 proceeds from step 406 to step 408 where Adaptation Layer 330 goes into the ‘Ready’ state.

In one aspect, the ‘End’ state denotes that no further action is taken by Adaptation Layer 330. In another aspect, when Adaptation Layer 330 enters the ‘End’ state, it returns an indication to Programming Interface 320 that there is no known NFC adaptor. In one aspect, when Adaptation Layer 330 enters the ‘Ready’ state, Programming Interface 320 may proceed with further actions, which may be determined by Application 310. In another aspect, when Adaptation Layer 330 enters the ‘Ready’ state, it returns an indication to Programming Interface 320 that an NFC adaptor is found and the necessary device drivers are loaded. Once Adaptation Layer 330 is in the ‘Ready’ state, Application 310 may be able to carry out any interaction or communication with the NFC adaptor, for example, via Programming Interface 320.

By way of example, the following will describe Application 310, Programming Interface 320, Adaptation Layer 330 and process 400 where Application 310 attempts to use a first NFC adaptor, NFC Adaptor 102, installed on or connected to Computing Device 101, but where no device drivers are loaded. In this example, Application 310 is a software application for reading NFC tags and using the information obtained to perform further actions—for instance, reading an NFC tag (for example, NFC Device 112) for product information and using that product information to search the Internet (e.g. Network 120 via Router 111 or Mobile Antenna 110) for pricing and purchase information. Here, Application 310 invokes Programming Interface 320, which in turn invokes Adaptation Layer 330, which in turn runs process 400. The process starts at step 401, and at step 402, NFC Adaptor 102 is found. Next, at step 403, Adaptation Layer 330 identifies NFC Adaptor 102 and at step 405 determines that NFC Adaptor 102 is supported by Computing Device 101. The process then proceeds to step 406 where Adaptation Layer 330 determines that device drivers are not loaded. As a result, Adaptation Layer 330 loads the necessary device drivers at step 407 and Adaptation Layer 330 then goes into the ‘Ready’ state at step 408. Once in the ‘Ready’ state, Application 310 will be able to read the NFC tag via NFC Adaptor 102 and Programming Interface 320. Application 310 may then carry out any other interactions or communications with NFC Adaptor 102 and process the information obtained from the NFC tag according to the instructions of Application 310.

By way of further example, NFC Adaptor 102 is replaced with a second NFC adaptor (not shown) that is not supported by Computing Device 101, and Application 310 attempts to use the second NFC adaptor (again to read an NFC tag). In this example, Application 310 invokes Programming Interface 320, which in turn invokes Adaptation Layer 330, which in turn runs process 400. The process starts at step 401, and at step 402, the second NFC adaptor is found. Next, at step 403, Adaptation Layer 330 identifies the second NFC adaptor and at step 405 determines that the second NFC adaptor is not supported. As a result, Adaptation Layer 330 enters the ‘End’ state.

In this manner, when a second NFC adaptor replaces a first NFC adaptor of Computing Device 101 and Application 310 attempts to operate the second NFC Adaptor, Programming Interface 320, Adaptation Layer 330, and process 400 will operate according to aspects of the present invention described above to load device drivers associated with the second NFC adaptor (if supported). This enables Application 310 to operate many different NFC adaptors via Programming Interface 320 without the need to modify Application 310.

Although illustrative embodiments have been shown and described herein in detail, it should be noted and will be appreciated by those skilled in the art that there may be numerous variations and other embodiments that may be equivalent to those explicitly shown and described. For example, the scope of the present invention is not necessarily limited in all cases to execution of the aforementioned steps in the order discussed. Unless otherwise specifically stated, terms and expressions have been used herein as terms of description, not of limitation. Accordingly, the invention is not to be limited by the specific illustrated and described embodiments (or the terms or expressions used to describe them).

What is claimed is:

1. A system for operating near field communications adaptors of a computing device, the system comprising:
(a) at least one memory having at least one region for storing executable program code; and
(b) at least one processor for executing the program code stored in the memory, wherein the program code, when executed:
(b)(i) makes a first determination of whether a near field communications adaptor is connected to the computing device;
(b)(ii) identifies the adaptor, wherein said identification is responsive to a first determination that a near field communication adaptor is connected to the computing device;
(b)(iii) makes a second determination of whether the computing device is adapted to communicate with the adaptor, wherein said making a second determination is responsive to the first determination that a near field communication adaptor is connected to the computing device; and
(b)(iv) loads at least one device driver for the computing device to communicate with the adaptor, wherein said loading is responsive to a second determination that the computing device is adapted to communicate with the adaptor.

2. The system of claim 1, wherein the computing device is a smart phone, tablet, portable computer, desktop computer, laptop computer, game console, personal media player, handheld computing device, or portable gaming device.

3. The system of claim 1, wherein the adaptor is capable of performing near field communications.

4. The system of claim 1, wherein the adaptor is internally connected to the computing device.

5. The system of claim 1, wherein the adaptor is externally connected to the computing device through wired or wireless means.

6. The system of claim 1, wherein the program code executes when an application stored in the memory communicates with the adaptor.

7. The system of claim 1, wherein the program code further executes function calls corresponding to the device drivers.

8. A method for operating near field communications adaptors of a computing device, the method comprising:
(a) making a first determination, by the computing device, of whether a near field communications adaptor is connected to the computing device, wherein the computing device includes at least one memory having at least one region for storing executable program code and at least one processor for executing the program code stored in the memory;
(b) identifying the adaptor by the computing device, wherein said identifying is responsive to a first determination that a near field communication adaptor is connected to the computing device;
(c) making a second determination, by the computing device, of whether the computing device is adapted to communicate with the adaptor, wherein said making a second determination is responsive to the first determination that a near field communication adaptor is connected to the computing device; and
(d) loading, by the computing device, at least one device driver for the computing device to communicate with the adaptor, wherein said loading is responsive to a second determination that the computing device is adapted to communicate with the adaptor.

9. The method of claim 8, wherein the computing device is a smart phone, tablet, portable computer, desktop computer, laptop computer, game console, personal media player, handheld computing device or portable gaming device.

10. The method of claim 8, wherein the adaptor is capable of performing near field communications.

11. The method of claim 8, wherein the adaptor is internally connected to the computing device.

12. The method of claim 8, wherein the adaptor is externally connected to the computing device through wired or wireless means.

13. The method of claim 8, wherein method is performed when an application stored in the memory communicates with the adaptor.

14. The method of claim 8, wherein the method further includes executing by the computing system function calls corresponding to the device drivers.

15. A system for operating near field communications adaptors of a computing device comprising:
(a) at least one memory having at least one region for storing executable program code;
(b) at least one processor for executing the program code stored in the memory;
(c) means for making a first determination of whether a near field communications adaptor is connected to the computing device;
(d) means for identifying the adaptor, wherein said identifying is responsive to a first determination that a near field communication adaptor is connected to the computing device;
(e) means for making a second determination of whether the computing device is adapted to communicate with the adaptor, wherein said making a second determination is responsive to the first determination that a near field communication adaptor is connected to the computing device; and
(f) means for loading at least one device driver for the computing device to communicate with the adaptor, wherein said loading is responsive to a second determination that the computing device is adapted to communicate with the adaptor.
